(19) United States
(12) Patent Application Publication
(10) Pub. No.: US 2007/0280122 A1
(43) Pub. Date: Dec. 6, 2007

(54) Network facsimile apparatus

(75) Inventor: Shuichi Ito, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/785,361

(22) Filed: Apr. 17, 2007

(30) Foreign Application Priority Data
Jun. 1, 2006 (JP) JP2006-153061

(51) Int. Cl. H04L 12/26

(52) U.S. Cl. 370/250

(57) ABSTRACT

By memorizing communication performance information of a destination machine captured in a previous transmission, the transmission is usually carried out using the communication performance of the destination machine memorized in destination machine performance memorizing device 25. However, in case a redirect response is returned from SIP server 10 when transmitting, the communication performance information is newly exchanged with the destination machine indicated by the redirect response, and then the transmission is carried out based on the communication performance information captured in the exchange. Or the transmission is carried out with default (standard) setting without exchanging the communication performance information.

This application is based on Japanese Patent Application No. 2006-153061 filed on 2006 Jun. 1, in Japanese Patent Office, the entire content of which is hereby incorporated by reference.

### BACKGROUND OF THE INVENTION

The present invention relates to a network facsimile apparatus wherein session control based on Session Initiation Protocol establishes a communication pass so as to carry out facsimile communication and in particular to a network facsimile apparatus which memorizes a communication performance of a destination machine captured in a previous transmission so as to determine transmission method based on the communication performance of the destination memorized for the next transmission.

As a network facsimile communication method, there is a method wherein transmitting and receiving apparatuses are connected in peer-to-peer fashion through a network such as Internet to transmit image data using Session Initiation Protocol (SIP). In SIP, a server (in practice configured with a proxy server, a register server, a location server and a redirect server) called a SIP server located in the network registers identification data (for example, a telephone number of fax in a public circuit) to identify a facsimile apparatus and an IP (internet protocol) address in relationship to one another. When a transmitting machine requests the SIP server a connection by a fax number of a destination, the SIP server retrieves the IP address corresponding to the fax number received from the transmitting machine to conduct calling connection between the transmitting machine and a receiving machine at the destination using the aforesaid IP address.

Also, in the SIP server, there is provided a function where the IP address registered in relation to the fax number is temporary changed to a proxy address (redirect address). When the transmitting machine requests a connection to the fax number to which the redirect address is set, the SIP server returns a redirect response including the redirect address currently set on a temporary basis to the transmitting machine.

Since such redirect address may go against an intention of a sender, there is suggested a network facsimile machine where the communication is forced to be disconnected in case the redirect response is notified (for example, refer to Unexamined Japanese Patent Application Publication No. 2005-94662).

Meanwhile, in the facsimile communication, since data is transmitted in a transmission method in accordance with performances of the destination machine (for example, recording sheet width, resolution and Color/monochrome), communication performance information is exchanged with the destination machine when communicating. Because the communication performance of the destination machine usually does not change, there is a network facsimile apparatus where the communication performance of the destination machine captured in a previous communication is memorized, then the transmission method for a next transmission is determined based on the memorized communication performance information of the destination machine so as to improve communication efficiency by omitting an exchange of the communication performance information for every transmission and to enable setting of a reading condition of a document before starting communication.

However, in case the redirect response is received from the SIP server at transmission, since the destination of transmission is substituted by a proxy receiving terminal (redirect destination), there can be a case where the communication performance of the aforesaid redirect destination is different from the communication performance of the destination machine which is captured in the previous communication. Thereby, if the transmission method is determined based on the communication performance of the destination machine memorized, a communication error can be caused.

### SUMMARY OF THE INVENTION

The present invention is summarized as follows:

1) A network facsimile apparatus which carries out session control based on Session Initiation Protocol, memorizes communication performance information of a destination machine captured in a previous communication for each transmission destination, and determines a communication method based on the communication performance information corresponding to the transmission destination for a next communication, wherein at a time of transmission to a first transmission destination, when a request is sent to a SIP server, if a redirect response is received from a redirect server, the communication performance information is exchanged with a second transmission destination notified by the redirect response without using the communication performance information of the first transmission destination memorized, and the transmission is carried out based on the communication performance information of the second transmission destination captured through the exchange.

2) A network facsimile apparatus which carries out session control based on Session Initiation Protocol having: a communication performance information exchange device to exchange communication performance information with a transmission destination; a memory device to memorize the communication performance information of the transmission destination captured by the communication performance information exchange device; a transmission method determination device, wherein in case communication with a first transmission destination of which the communication performance information is already memorized in the memory device is carried out, a transmission method is determined based on the communication performance information of the first transmission destination memorized in the memory device without operating the communication performance information exchange device, and if a redirect response is received from a redirect server when a SIP server is requested a connection with the first transmission destination, even in case communication with the first transmission destination is carried out, the communication performance information exchange device carries out an exchange of the communication performance information with the second transmission destination notified by the redirect response, and the transmission method is determined based on the communication performance information of the second transmission destination captured through the exchange; and a transmission device to carry out transmission with the transmission method determined by the transmission method determination device.

3) A network facsimile apparatus which carries out session control based on Session Initiation Protocol, memorizes communication performance information of a destination machine captured in a previous communication for each transmission destination, and determines a communication method based on the communication performance information corresponding to the transmission destination for a next communication, wherein at a time of transmission to a first transmission destination, when a request is sent to a SIP server, if a redirect response is received from a redirect server, transmission is carried out based on default communication performance information set in own machine without using the communication performance information of the first transmission destination memorized.

4) A network facsimile apparatus which carries out session control based on Session Initiation Protocol having: a default setting memory device to memorize default communication performance information set in own machine; a communication performance information exchange device to exchange communication performance information with a transmission destination; a memory device to memorize the communication performance information of the transmission destination captured by the communication performance information exchange device; a transmission method determination device, wherein in case communication with a first transmission destination of which the communication performance information is already memorized in the memory device is carried out, a transmission method is determined based on the communication performance information of the first transmission destination memorized in the memory device without operating the communication performance information exchange device, and if a redirect response is received from a redirect server when a SIP server is requested a connection with the first transmission destination, even in case communication with the first transmission destination is carried out, the transmission method is determined based on the default communication performance information memorized in the default setting memory device; and a transmission device to carry out transmission with the transmission method determined by the transmission method determination device.

### BRIEF DESCRIPTION OF THE DRAWINGS

FIG. 1 is an explanatory drawing showing an example of a structure of a network facsimile system related to a first embodiment of the present invention.

FIG. 2 is a flow chart indicating a transmission process to be conducted by a transmitting side facsimile apparatus related to the first embodiment.

FIG. 3 is a diagram explaining a process of establishing a session in SIP.

FIG. 4 is an explanatory drawing exemplifying registered data of abbreviated destinations

FIG. 5 is a block diagram indicating a functional configuration of a transmitting side facsimile apparatus related to a second embodiment.

FIG. 6 is a flow chart indicating a transmission process conducted by the transmitting side facsimile apparatus related to the second embodiment.

FIG. 7 is a front view showing an example of a default transmission confirmation screen displayed by the transmitting side facsimile apparatus related to the second embodiment.

### DETAILED DESCRIPTION OF THE PREFERRED EMBODIMENT

With reference to the drawings, the following embodiments are described.

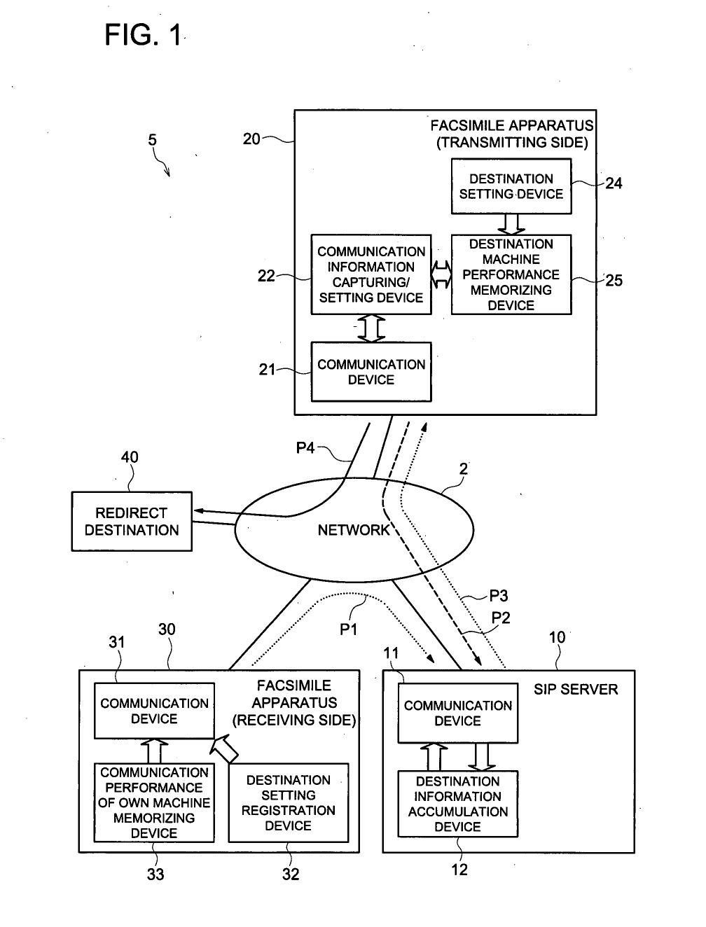

FIG. 1 shows an example of a configuration of network facsimile system 5 related to a first embodiment of the present invention. Network facsimile system 5 is a facsimile system so structured as to conduct calling connection using Session Initiation Protocol and to transmit the image data by interconnecting the receivers and the transmitters on peer-to-peer fashion basis through network 2, and network facsimile system 5 is configured by connecting SIP server 10, transmitting side facsimile apparatus 20, receiving side facsimile apparatus 30 and facsimile apparatus 40 representing a redirect destination.

Meanwhile, number of each apparatus 10, 20, 30 and 40 connected to network 2 is not limited to the number shown in the figure. A plurality of apparatuses can be connected.

In practice, SIP server 10 is configured with a plurality of servers such as a proxy server, a register server, a location server, and a redirect server. Transmitting side facsimile apparatus 20, receiving side facsimile apparatus 30, redirect destination 40 are configured as network facsimile apparatuses which respectively conduct session control based on session initiation protocol. Each of the above apparatuses is provided with a control section having CPU (Central Processing Unit) as a main part, a scanning section to obtain image data by optically reading a document, a printer section to print an image on a recording sheet, an operation display section to display an operation screen and to receive operation of an user, and a hard disc to memorize the image data. The above sections are all unillustrated.

In network facsimile system 5, receiving side facsimile apparatus 30 in advance registers destination information in which identification data (here a telephone number (fax number) of the fax in a public line) to identify own machine in respect to SIP server 10 and address information (here, its own IP address) are related each other (FIG. 1, P1).

When SIP server 10 receives a connection request from transmitting side facsimile apparatus 20 with a fax number of receiving side facsimile apparatus 30 (P2), SIP server 10 retrieves an IP address registered in relation to its fax number and conducts a calling connection between transmitting side facsimile apparatus 20 and receiving side facsimile apparatus 30 using the aforesaid IP address. The transmission method of image data after calling connection is discretionary. For example, protocols in conformity with T3.8 or T.37 advised by ITU-T (International Telecommunication Union-Telecommunication sector) are used.

Also, receiving side facsimile apparatus 30 can temporally register destination information including the IP address of other machine (redirect destination), which is different from that of own machine, in SIP server 10 in relation to the fax number of own machine (This registration is called redirect setting) (P1 in FIG. 1). When transmitting side facsimile apparatus 20 requests a connection to a fax number where redirect setting is done (P2), SIP server 10 informs the destination information of redirect destination 40, which is currently and temporally set for the fax number, to transmitting side facsimile apparatus 20 representing a connection requester from a redirect server as a redirect response (P3). Transmitting side facsimile apparatus 20 can execute a facsimile transmission to the redirect destination, which is informed by the redirect response (P4).

Receiving side facsimile apparatus 30 includes functions as communication device 31, destination setting and registration device 32, and performance memorizing device of own machine 33. Communication device 31 performs a function to communicate with SIP server 10 and other facsimile apparatuses through network 2. Destination setting and registration device 32 performs a function to receive setting operation of the redirect destination from the user and to conduct redirect setting by transmitting the destination information of the redirect destination set to SIP server 10. Performance memorizing device of own machine 33 memorizes communication performance information indicating communication performance of own machine and communication device 31 exchanges the communication performance information memorized in performance memorizing device of own machine 33 with that of a destination machine when communicating. The communication performance information includes, for example, receivable sheet size, receivable resolution and color capability in receiving.

SIP server 10 has functions of communication device 11 and destination information accumulating device 12. Communication device 11 carries out functions of communication with facsimile apparatuses 20, 30 and 40 through network 2. Destination information accumulating device 12 carries out functions to memorize and to relate the fax number, information indicating whether or not the fax number is being redirected and the IP address (redirect address) set for the fax number.

Transmitting side facsimile apparatus 20 is provided with functions as communication device 21, communication information capturing/setting device 22, transmission destination setting device 24 and destination machine performance memorizing device 25.

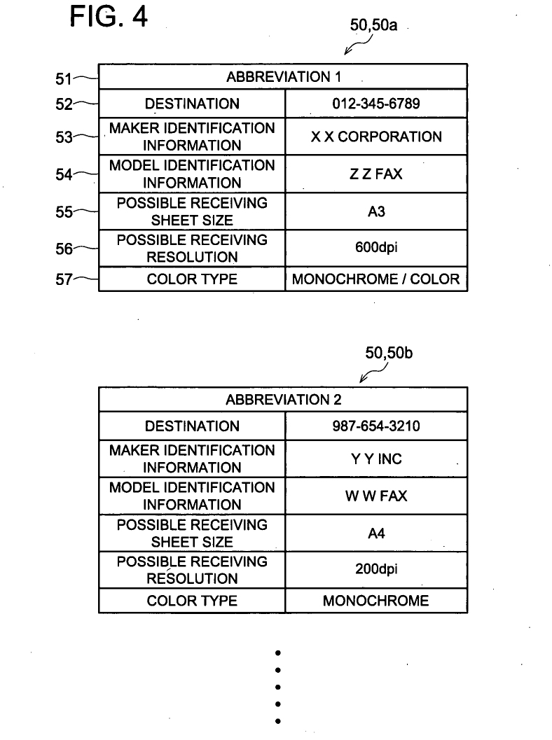

Communication device 21 carries out a function to communicate with SIP server 10 and facsimile apparatuses 30 and 40 through network 2. Transmission destination setting device 24 carries out a function to receive a setting of the destination (destination machine) from the user when a facsimile transmission is executed. The transmission destination is memorized in an unillustrated nonvolatile memory as an abbreviated destination. In the abbreviated destination data, the fax number of the abbreviated destination and the communication performance information are registered in relation to the abbreviated destination number. The details are shown in FIG. 4.

Communicating with other apparatuses 10, 30 and 40, communication information capturing/setting device 22 carries out functions to create, manage and accumulate information to be sent to other devices and to manage and accumulate information received from other devices. Also, communication information capturing/setting device 22 carries out functions as a transmission performance information exchanging device to exchange transmission performance information with the destination machine and as a transmission method determination device to determine a transmission method for a transmission. Destination machine performance memorizing device 25 carries out a function as a memory device to memorize the communication performance information of a destination machine captured in a previous communication.

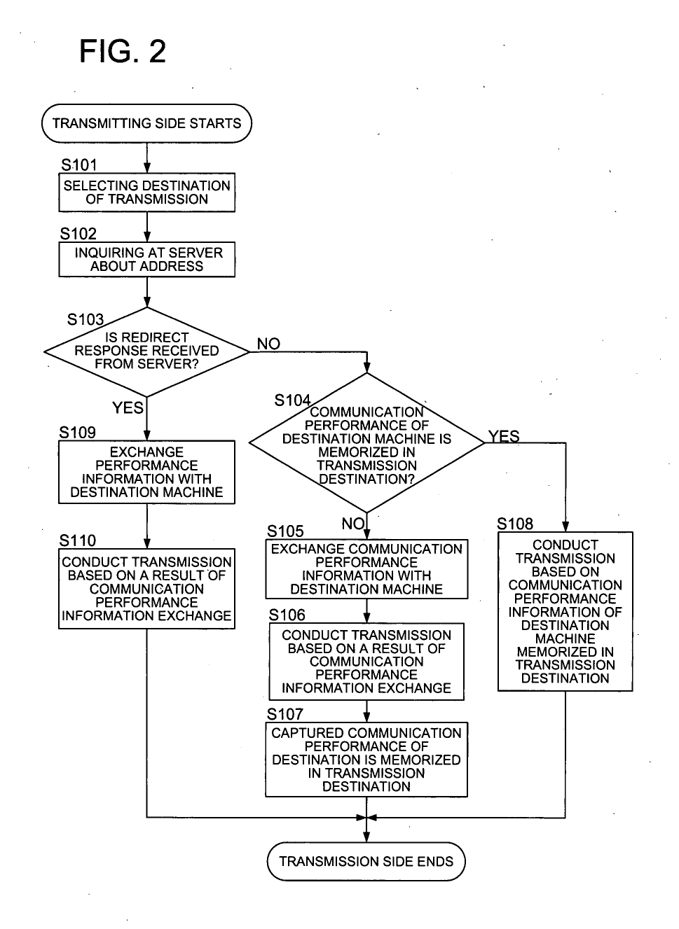

FIG. 2 shows a flow of a transmission process carried out by transmitting side facsimile apparatus 20. When transmission destination setting device 24 receives information of a selected transmission destination which is selected by assigning, for example, the abbreviated destination number (step S101), transmitting side facsimile apparatus 20 inquires SIP server 10 about the IP address assigned in relation to the fax number of the transmission destination (first transmission destination)(step S102). Meanwhile, in case the transmission destination is not registered in abbreviated destination data, the user carries out registration operation in the abbreviated destination data before the transmission.

In case a response received from SIP server 10 in response to the inquiry in step S102 is not the redirect response (step S1023: N), whether or not the communication performance information of the destination machine is already memorized in relation to a selected abbreviated destination number is searched (step S104). If it is not memorized, (step S104: N), communication performance information is exchanged with the destination machine of transmission destination (step S105) and the transmission is executed based on the communication performance information captured in the exchange (step S106).

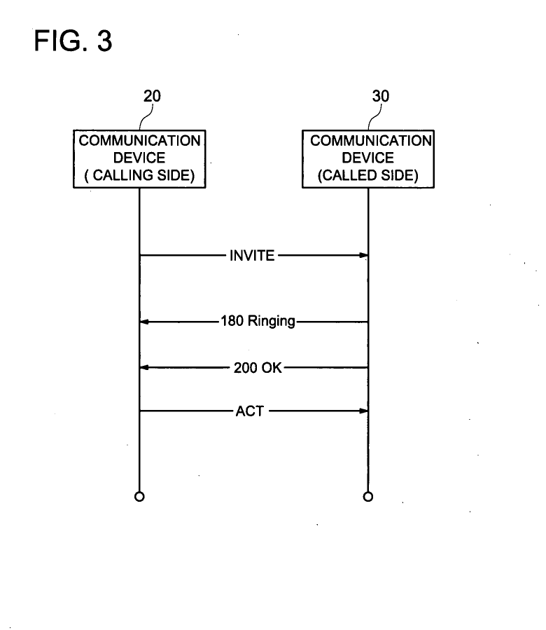

The communication performance information can be captured by a response “180 ringing” or a response “200 OK” in a session establishing process by SIP shown in FIG. 3. Also, the communication performance information of the destination machine captured here is registered corresponding to the abbreviated destination number related to this time's transmission.

FIG. 4 exemplifies registration data 50 of the abbreviated destinations. For each abbreviated destination, records 50 are prepared so as to register information corresponding to the abbreviated destinations, and the communication performance information captured in communication performance information exchange is registered in the records corresponding. In the examples in FIG. 4, each record 50a and 50b provides fields to register abbreviated destination number 51 assigned to the abbreviated destination, fax number 52 of the destination (destination machine), maker identification data 53 to indicate a manufacturer of the destination (destination machine), model identification data 54 to indicate a model of the destination (destination machine), receivable sheet size 55 of the destination (destination machine), receivable resolution 56 of the destination (destination machine) and color type 57 to distinct whether the destination (destination machine) is color unit or monochrome unit.

In case the response received from SIP server 10 is not a redirect response (step S103: N) and the communication performance information of the destination is recorded corresponding to the selected abbreviated destination number (step S104: Y), the transmission is executed using the communication performance information of the destination (first transmission destination) (step S108).

In case the response received from SIP server 10 (redirect server) is a redirect response (step S103: Y), the communication performance information is exchanged with the destination machine (second transmission destination) informed by the redirect response (step S109) and the transmission is executed based on the communication performance information captured in the exchange (step S110). The communication performance information can be captured by the response “180 Ring” or the response “200 OK” in the session establishing process by SIP shown by FIG. 3.

In case redirect response is received, because the destination machine (second transmission destination) is a proxy destination temporally set, the communication performance information captured from the aforesaid redirect destination is not registered corresponding to the abbreviated destination number of relevant destination (first transmission destination). Thereby, the communication performance information originally registered corresponding to the relevant abbreviated destination number is prevented from distracting by overwriting the communication performance information of the redirect destination, and after the redirect setting is released, the communication performance information of the destination machine (first transmission opponent) captured and memorized in a previous communication is used again to execute a transmission.

Next, a second embodiment of the present invention is described.

In the second embodiment, in case the redirect response is received from SIP server 10, transmission is executed using a communication performance (or a communication method) of a default setting memorized in transmitting side facsimile apparatus 20 in advance.

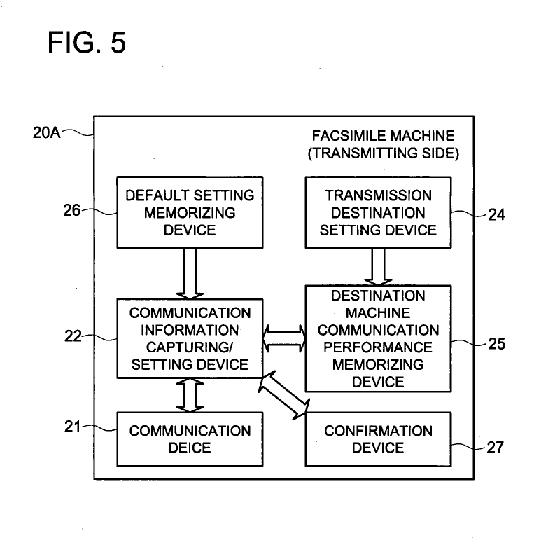

FIG. 5 shows a functional structure of transmitting side facsimile apparatus 20A related to the second embodiment. The second embodiment is different from the first embodiment in an aspect that a default setting memory device 26 and confirmation device 27 are further provided. The portions having the same structure as that of transmitting side facsimile apparatus 20 related to the first embodiment are denoted by the same symbols.

Default setting memorizing device 26 memorizes communication performance information indicating a default communication performance set by own machine. In default setting memorizing device 26, a minimum performance (standard performance) which is prescribed to any facsimile apparatuses when communicating through network facsimile system 5 is registered as default communication performance information. In case transmission is carried out with the default setting by receiving the redirect response from SIP server 10, confirmation device 27 carries out a function to receive a confirmation that transmission is executed with the default setting from the user.

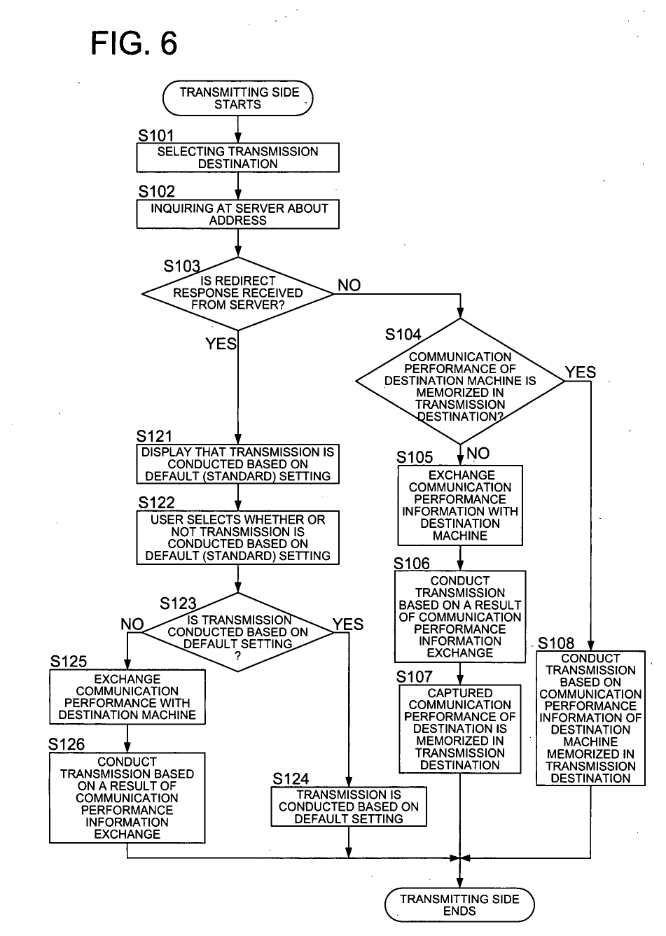

FIG. 6 shows a flow of a transmission process carried out by transmitting side facsimile apparatus 20A. A difference from the process shown in FIG. 2 is only an operation when the redirect response is received. The other operations (such operation in case a response is not the redirect response) are the same as the one shown in FIG. 2, and the same portions of the operations are denoted by the same step numbers.

In case a response received from SIP server 10 (redirect server) is the redirect response (step S103: Y), the user is informed that the transmission is carried out with default (standard) setting memorized in default setting memorizing device 26 through confirmation device 27 (such as an unillustrated operation display section) (step S121) then a confirmation (endorsement) operation is received from the user (step S122)

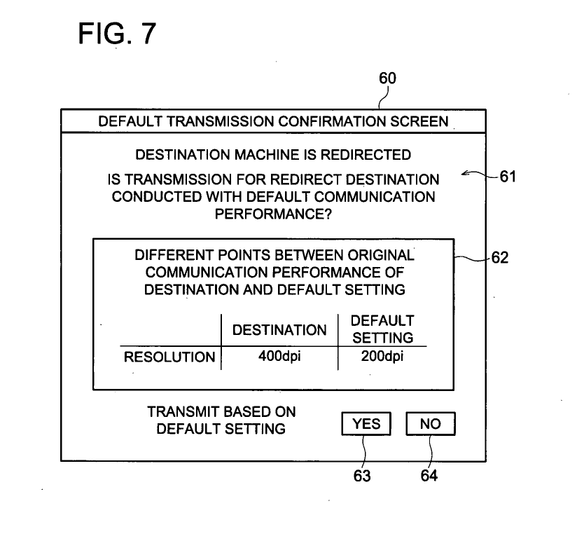

FIG. 7 shows an example of default transmission confirmation screen 60 to show a notification and to receive a confirmation of carrying out the transmission with the default setting. Default transmission confirmation screen 60 indicates a message 61 that the transmission is carried out with the default transmission performance since the transmission is for the redirect destination, communication performance difference 62 between that of the original transmission destination and the default setting, and “Yes” button 63 and “No” button 64 to accept the operations from the user whether or not the transmission with the default setting is confirmed (endorsed).

When the user confirms (endorses) that the transmission is carried out (step S123: Y) with the default setting, the transmission is carried out with the default setting (standard setting) memorized in default setting memory device 26 without exchanging the communication performance information (step S124). Since the default setting allows a transmission with a minimum communication performance, even if the transmission destination has the different communication performance from the original destination, an error cannot be caused by the difference of the communication performance.

In case the user refuses the transmission with the default setting (step S123: N), the communication performance information is exchanged with the destination machine (step S125) and the transmission is carried out based on the communication performance information obtained in the exchange (step S126). Meanwhile, the communication performance information obtained is not memorized corresponding to the abbreviated destination number.

As above, the embodiments of the present invention are described with reference to the drawings without practical structures being restricted by the embodiments thereto, and it is to be understood that changes and variations without departing from the spirit or scope are included in the present invention.

For example, in the second embodiment, in case the redirect response is received, a confirmation for transmitting with default setting is received from user. However, the transmission with the default setting may be executed without receiving the confirmation from the user.

Also, in FIG. 6, in case the user does not confirm (endorse) the transmission with the default setting, the communication performance information is exchanged with the destination machine however, the transmission may be ceased in case the user does not confirm.

Further, contents of the default setting memorized in default setting memorizing device 26 can be altered arbitrarily by the user, other than the minimum performance.

What is claimed is:

1. A network facsimile apparatus which carries out session control based on Session Initiation Protocol, memorizes communication performance information of a destination machine captured in a previous communication for each transmission destination, and determines a communication method based on the communication performance information corresponding to the transmission destination for a next transmission, wherein
at a time of transmission to a first transmission destination, when a request is sent to a SIP server, if a redirect response is received from a redirect server, the communication performance information is exchanged with a second transmission destination notified by the redirect response without using the communication performance information of the first transmission destination memorized, and the transmission is carried out based on the communication performance information of the second transmission destination captured through the exchange.

2. A network facsimile apparatus which carries out session control based on Session Initiation Protocol comprising:
a communication performance information exchange device to exchange communication performance information with a transmission destination;
a memory device to memorize the communication performance information of the transmission destination captured by the communication performance information exchange device;
a transmission method determination device, wherein in case communication with a first transmission destination of which the communication performance information is already memorized in the memory device is carried out, a transmission method is determined based on the communication performance information of the first transmission destination memorized in the memory device without operating the communication performance information exchange device, and if a redirect response is received from a redirect server when a SIP server is requested a connection with the first transmission destination, even in case communication with the first transmission destination is carried out, the communication performance information exchange device carries out an exchange of the communication performance information with the second transmission destination notified by the redirect response, and the transmission method is determined based on the communication performance information of the second transmission destination captured through the exchange; and
a transmission device to carry out transmission with the transmission method determined by the transmission method determination device.

3. The network facsimile apparatus of claim 1, wherein the communication performance information of the second transmission destination captured through the communication performance information exchange with the second transmission destination notified by the redirect response is not memorized.

4. The network facsimile apparatus of claim 2, wherein the communication performance information of the second transmission destination captured through the communication performance information exchange with the second transmission destination notified by the redirect response is not memorized.

5. A network facsimile apparatus which carries out session control based on Session Initiation Protocol, memorizes communication performance information of a destination machine captured in a previous communication for each transmission destination, and determines a communication method based on the communication performance information corresponding to the transmission destination for a next communication, wherein
at a time of transmission to a first transmission destination, when a request is sent to a SIP server, if a redirect response is received from a redirect server, transmission is carried out based on default communication performance information set in own machine without using the communication performance information of the first transmission destination memorized.

6. A network facsimile apparatus which carries out session control based on Session Initiation Protocol comprising:
a default setting memory device to memorize default communication performance information set in own machine;
a communication performance information exchange device to exchange communication performance information with a transmission destination;
a memory device to memorize the communication performance information of the transmission destination captured by the communication performance information exchange device;
a transmission method determination device, wherein in case communication with a first transmission destination of which the communication performance information is already memorized in the memory device is carried out, a transmission method is determined based on the communication performance information of the first transmission destination memorized in the memory device without operating the communication performance information exchange device, and if a redirect response is received from a redirect server when a SIP server is requested a connection with the first transmission destination, even in case communication with the first transmission destination is carried out, the transmission method is determined based on the default communication performance information memorized in the default setting memory device; and
a transmission device to carry out transmission with the transmission method determined by the transmission method determination device.

7. The network facsimile apparatus of claim 5, further comprising a confirmation device to receive a confirmation that transmission is carried out based on the default communication performance information from a user when the transmission is carried out based on the default communication performance information.

8. The network facsimile apparatus of claim 6, further comprising a confirmation device to receive a confirmation that transmission is carried out based on the default communication performance information from a user when the transmission is carried out based on the default communication performance information.
